(19) United States
(12) Patent Application Publication
(10) Pub. No.: US 2021/0239499 A1
(43) Pub. Date: Aug. 5, 2021

(54) DEVICE FOR INDICATING AND/OR CHECKING FLUIDS

(71) Applicant: HYDAC ACCESSORIES GMBH, Sulzbach/Saar (DE)

(72) Inventors: Jürgen KÄFER, Schiffweiler (DE); Markus HANUS, St. Ingbert (DE)

(21) Appl. No.: 17/053,132

(22) PCT Filed: Apr. 12, 2019
(86) PCT No.: PCT/EP2019/059480

§ 371 Date: Nov. 5, 2020

(30) Foreign Application Priority Data
May 7, 2018 (DE) 10 2018 003 727.5

(51) Int. Cl. G01F 1/22; G01F 23/02

(52) U.S. Cl. CPC G01F 1/22; G01F 23/02

(57) ABSTRACT

The invention relates to a device for the display and/or control of fluids, comprising at least one fluid connection (30, 32), which opens out into a riser pipe (2), which is at least partially surrounded by a frame (8), in the front wall (6) of which there is a recess (40), which releases a viewing area (4) for monitoring the fluid level in the riser pipe (2), characterised in that a cover is provided which can be mounted on the recess (40) so as to be removable and forms a protection window (42) protecting the riser pipe (2) from outside against mechanical influences in the viewing area (4).

The invention relates to a device for indicating and/or checking fluids, having at least one fluid port, which opens out into a riser pipe, which is at least partially surrounded by a frame, in the front wall of which a recess is arranged, which exposes a viewing area for observing the fluid level in the riser pipe.

A device of this type is shown in document DE 10 2009 007 655 A1 by way of example. Such devices, also known as liquid level gauges (LLG) or liquid level check (LLC), are used to display the level of a liquid inside a container, wherein the device is attached outside the container, but via at least one fluid port connected thereto in the manner of communicating tubes. For such a device, the respective current filling level can be detected by visually observing the fluid level in the riser pipe, or an electrical display signal can be generated at a pre-settable value of the filling level by detecting the position of a floating body in the riser pipe using a sensor device. For such devices, a glass tube is often used as a riser pipe. For applications at rough operating conditions, such as mobile applications, there is a risk of damage to the glass tube, for example by stone chipping or the like.

With regard to this problem, the invention addresses the problem of providing a device of the genus mentioned at the beginning, which is characterized by a high degree of operational reliability, even at rough ambient conditions.

According to the invention, this problem is solved by a device having the features of claim 1 in its entirety.

According to the characterizing part of claim 1, an essential feature of the invention is that a cover is provided, which can be detachably attached to the recess and forms a protection window protecting the riser pipe in the viewing area against mechanical action from the outside. A riser pipe, formed as a glass tube, is thus largely protected from direct impact from outside, so that the device according to the invention can also be used safely in applications such as mobile equipment.

The protection window can advantageously be made of a material that allows the view on the riser pipe, such that the fluid level is visually recognizable even when the protection window is attached.

In advantageous embodiments, the protection window is formed in one piece form a transparent, UV-resistant plastic material, such as PA.

The arrangement can be made with advantage so that the protection window is formed by a flat plate, the outline of which is adapted to the outline of the recess in the front wall of the frame. In the attached position, the protection window thus forms a full-surface cover of the recess.

In embodiments where the frame is formed by a metal profile strip having a mainly U-shaped cross-section, the thickness of the plate of the protection window corresponds to preferably at least the wall thickness of the profile strip of the frame.

To form a snap connection with the edge of the recess of the frame, the protection window can advantageously have yielding hook parts, so that the protection window is easily attachable to the frame by clipping and, for example in the event of damage, can be installed and removed without significant effort.

In embodiments in which the recess of the frame has a rectangular shape having rounded corner areas and having long sides running along the riser pipe, the protection window can advantageously have on its long sides the hook parts for engaging under the edge of the long sides of the recess of the frame.

Advantageously the arrangement may be such that on each narrow end of the plate of the protection window a stop body, projecting from the plane of the plate in the direction of the hook parts is provided, wherein said stop body engages with the recess and secures the protection window in the vertical direction by contacting on the assigned narrow-sided edge of the recess.

In addition, the edge of the protection window may have on at least one narrow side an area protruding from the plane of the plate in the direction of the front side. This area can form a point of action for the application of a tool for releasing the snap connection for removing the protection window.

According to claim 10, subject matter of the invention is also a protection window, which is provided to form a cover, in particular for the viewing area of a device according to one of the claims 1 to 9, and can be detachably attached to the recess of the frame of the same.

Below the invention is explained in detail with reference to embodiments shown in the drawing. In the Figures:

FIG. 1 shows a perspective oblique view of a device for a liquid level check (LLC) according to the state of the art, viewed towards the front wall and the riser pipe shown cut open;

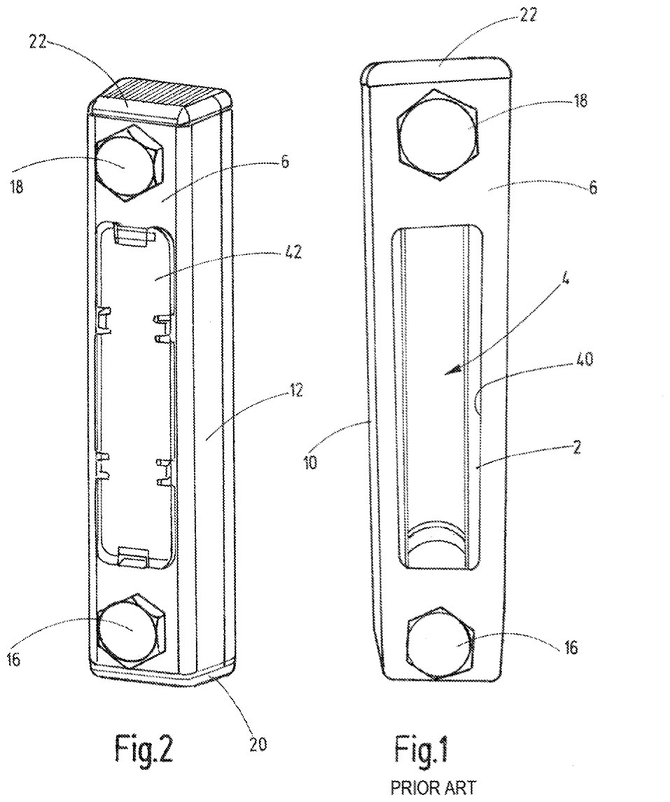

FIG. 2 shows a perspective oblique view of an embodiment of the device for displaying and/or checking fluids according to the invention;

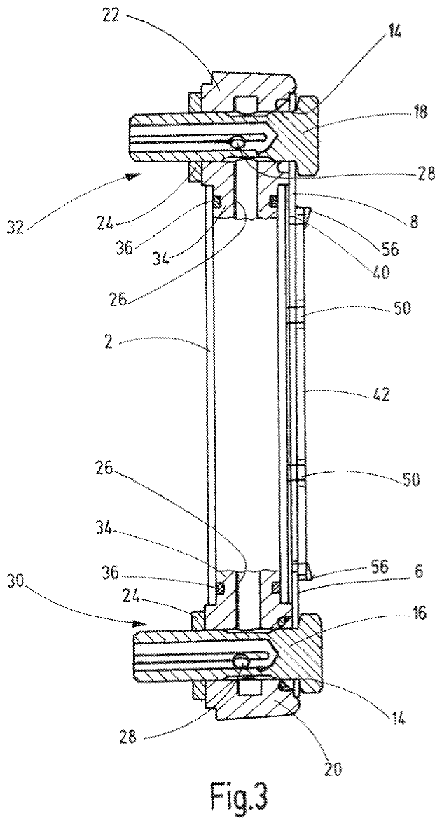

FIG. 3 shows a vertical section of the embodiment of the device according to the invention;

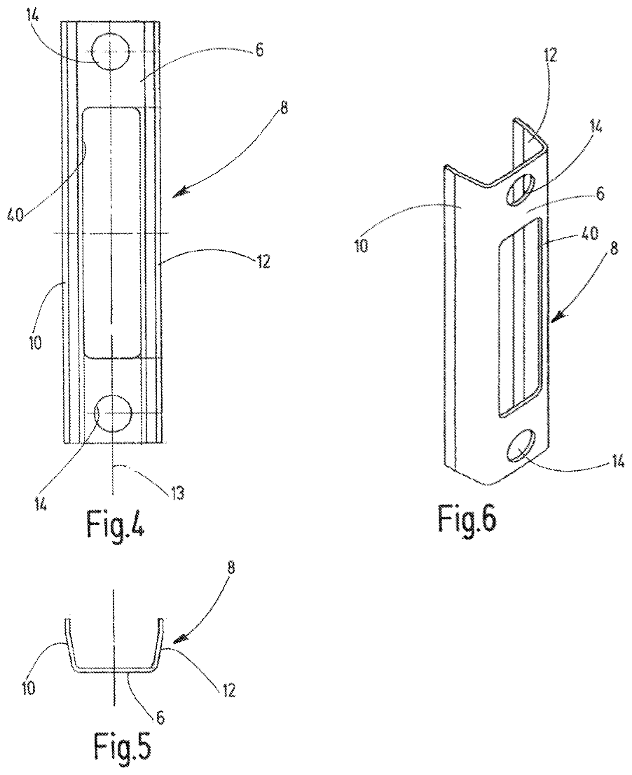

FIGS. 4 and 5 show a front view of the frame of the embodiment;

FIG. 6 shows a perspective oblique view of the frame of FIGS. 4 and 5;

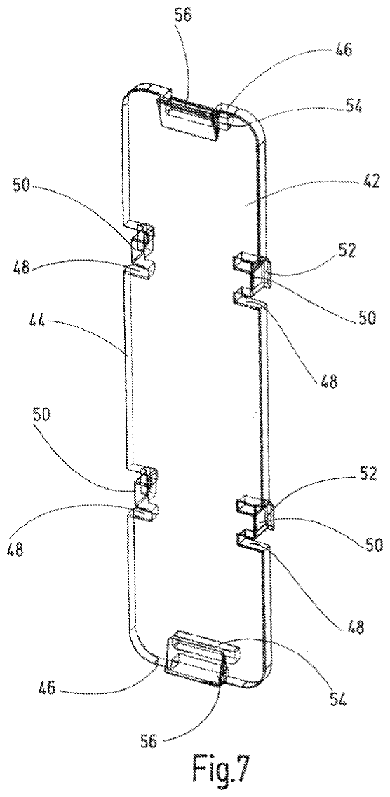

FIG. 7 shows a perspective oblique view of the protection window that can be attached to the frame of FIGS. 4 to 6;

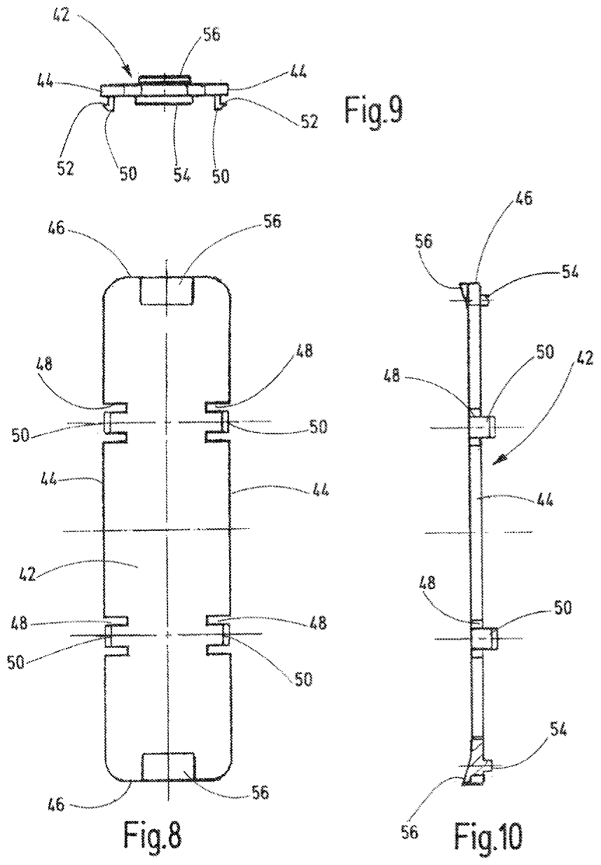

FIG. 8 shows a top view of the protection window;

FIGS. 9 and 10 show a front view and a side view of the protection window of FIG. 8;

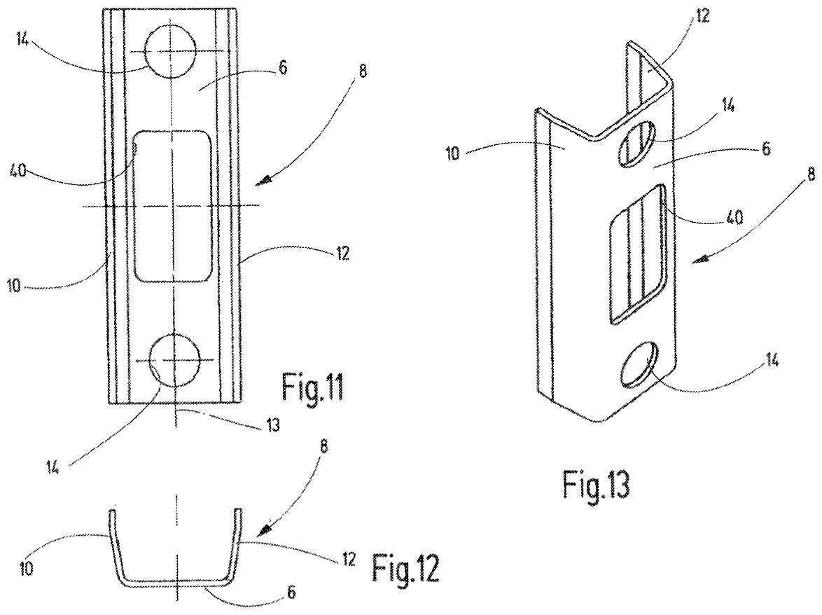

FIGS. 11 and 12 show a front view of the frame of a second embodiment of the device according to the invention;

FIG. 13 shows a perspective oblique view of the frame of the second embodiment;

FIG. 14 shows a top view of the protection window of the second embodiment; and

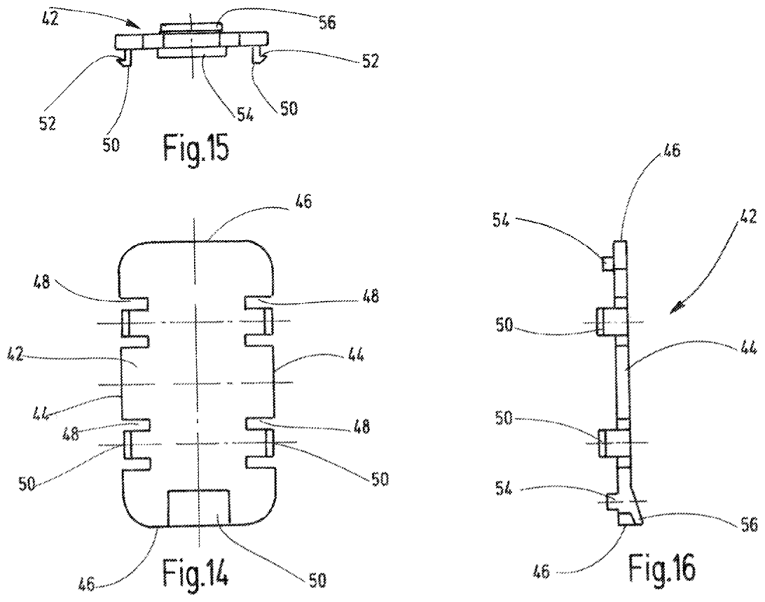

FIGS. 15 and 16 show a front view and a side view of the protection window of the second embodiment.

With reference to the attached drawing, the invention is described using the example of a liquid level gauge (LLG) as revealed in document DE 10 2009 007 655 A1 mentioned above. FIG. 1 shows this state-of-the-art device, wherein a riser pipe 2, which can be observed in a viewing area 4 on the front wall 6 of the device, is cut open and shown without a floating body possibly located therein. As in the known solution mentioned above, the front wall 6 is part of a housing frame 8, which is shown separately in FIGS. 4 to 6, and, as shown there, is formed by an aluminum profile strip, which has a U-shaped cross-section having lateral profile legs 10 and 12, which laterally adjoin to the profile web forming the front wall 6 and laterally surround the riser pipe 2. On the longitudinal axis 13, one hole 14 each is formed in the front wall 6 near the upper and lower end. By means of hollow screws 16 and 18, reaching through the bores 14, the frame 8 is, as can be seen most clearly in FIG. 3, attached to a lower connection body 20 and to an upper connection body 22 each by means of a nut 24. The lower connection body 20 forms with a coaxial blind bore 26 and a transverse bore 28 in the lower hollow screw 16 (FIG. 3) a lower fluid port 30. In the same way, an upper fluid port 32 is formed on the upper connection body 22 by its blind bore 26 and the transverse bore 28 of the upper hollow screw 18. As can also be seen in FIG. 3, for fixing the riser pipe 2 the lower and upper connection bodies 20 and 22 each have a circular cylindrical, axially projecting receptacle part 34, which engages with the assigned end part of the riser pipe 2, wherein a sealing ring 36 forms the seal.

To expose the viewing area 4 (FIG. 1), in the front wall 6 of frame 8 a recess 40, running in parallel to the axis 13, in the form of a rectangle having rounded corner areas is formed. The recess 40 can be closed by means of a detachable protection window 42, the details of which are shown in FIGS. 7 to 10. The protection window 42 has the shape of a flat, plane plate, the outline of which is adapted to the outline of the recess 40, i.e. it is rectangular in shape having long sides 44 and narrow ends 46 and rounded corner areas. The thickness of the plate of the protection window 42 is equal or slightly greater than the thickness of the metal profile strip of the frame 8. For example, if the frame 8 has a wall thickness of 1.5 mm, the plate thickness of the protection window 42 can be 2.0 mm. Advantageously a plastic material such as PA can be provided as the material for the protection window 42, preferably a crystal-clear material, facilitating the visual observation of the riser pipe 2, such as Trogamid® T.

FIG. 2 shows the protection window 42 in the position attached to the recess 40, wherein in said position it is held by clipping it to the edge of the long sides of the recess 40. For this purpose, incisions 48 are made in each long side 44 in a position halfway between the narrow side 46 and the mid-length of the long sides, wherein by said incisions 48 elastic hook parts 50 are cut out. As FIGS. 7 to 10 show most clearly, the hook parts 50 extend away from the rear side of the protection window 42 such that in the attached position their holding surfaces 52 engage behind the edge of the recess 40. While the hook parts 50 safeguard the protection window 42 against being lifted from the front wall 6 and against displacement in the horizontal direction, stop bodies 54 in the form of short strips safeguard against displacement in the vertical direction, wherein said stop bodies 54 run along the narrow sides 46 at the upper and lower end of the protection window 42 and project from the plate plane in the direction of the hook parts 50. In the attached position, the stop bodies 54 engage in the recess 40 and secure the protection window 42 by contacting on the narrow-sided edge of the recess 40. At the top of the protection window 42, an upwardly projecting area 56 is formed in alignment with the respective stop body 54, as shown in FIGS. 9 and 10. When the protection window 42 is attached, the area 56, projecting from the plate plane of the protection window 42, forms a point of action for the application of a tool for unlatching the clipping for the removal and/or replacement of the protection window 42.

FIGS. 11 to 13 show the frame 8 of a second embodiment. This corresponds to the first embodiment, apart from the fact that it is constructed for a shorter length of the riser pipe 2 having a correspondingly shorter viewing area 4 and that the frame 8 and the recess 40 have a correspondingly smaller vertical extension. In further contrast to the first embodiment, the protection window 42, the length of which is adapted to the shorter viewing area 4, is only provided on a narrow side 46, which is at the bottom in FIGS. 14 and 16, with an area 56 projecting from the plate plane in the direction of the front side. As FIGS. 14 to 16 show, the remaining details of the protection window 42 of the second example, such as the safeguarding against being lifted off by means of the hook parts 50 or the safeguarding in the vertical direction by means of the stop bodies 54, each correspond to the first embodiment.

1. A device for indicating and/or checking fluids, having at least one fluid port (30, 32), which opens out into a riser pipe (2), which is at least partially surrounded by a frame (8), in the front wall (6) of which a recess (40) is arranged, which exposes a viewing area (4) for observing the fluid level in the riser pipe (2), characterized in that a cover is provided, which can be detachably attached to the recess (40) and forms a protection window (42) protecting the riser pipe (2) in the viewing area (4) against mechanical effects from the outside.

2. The device according to claim 1, characterized in that the protection window (42) is formed from a material permitting the view on the riser pipe (2).

3. The device according to claim 1, characterized in that the protection window (42) is formed in one piece from a transparent, UV-resistant plastic material, such as PA.

4. The device according to claim 1, characterized in that the protection window (42) is formed by a flat plate, the outline of which is adapted to the outline of the recess (40) in the front wall (6) of the frame (8).

5. The device according to claim 1, characterized in that the frame (8) is formed by a metal profile strip having a mainly U-shaped cross-section and that the thickness of the plate of the protection window (42) corresponds to at least the wall thickness of the profile strip of the frame (8).

6. The device according to claim 1, characterized in that the protection window (42) has resilient hook parts (50) for forming a snap connection with the edge of the recess (40) of the frame (8).

7. The device according to claim 1, characterized in that the recess (40) has a rectangular shape having rounded corner areas and having long sides running along the riser pipe (2) and that the protection window (42) has on its long sides (44) the hook parts (50) for engaging under the edge of the long sides of the recess (40) of the frame (8).

8. The device according to claim 1, characterized in that on each narrow end (44) of the plate of the protection window (42) a stop body (54), projecting from the plane of the plate in the direction of the hook parts (50) is provided, wherein said stop body (54) engages with the recess (40) and secures the protection window (42) in the vertical direction by contacting on the assigned narrow-sided edge of the recess (40).

9. The device according to claim 1, characterized in that the edge of the protection window (42) has on at least one narrow side (46) an area (56) protruding from the plane of the plate in the direction of the front side.

10. A protection window, which is provided to form a cover, in particular for the viewing area (4) of a device according to claim 1, and can be detachably attached to the recess (40) of the frame (8) of the same.
